(19) United States
(12) Patent Application Publication
(10) Pub. No.: US 2024/0070527 A1
(43) Pub. Date: Feb. 29, 2024

(54) DIGITAL TWIN BASED EVALUATION, PREDICTION, AND FORECASTING FOR AGRICULTURAL PRODUCTS

(71) Applicant: Bank of America Corporation, Charlotte, NC (US)

(72) Inventors: Maharaj Mukherjee, Poughkeepsie, NY (US); Carl M. Benda, Charlotte, NC (US)

(21) Appl. No.: 17/899,779

(22) Filed: Aug. 31, 2022

(51) Int. Cl. G06N 20/00; G06Q 10/04

(52) U.S. Cl. CPC G06N 20/00; G06Q 10/04

(57) ABSTRACT

Aspects of the disclosure relate to digital twin simulation. A computing platform may receive historical information. The computing platform may train, using the historical information, a digital twin model, configured to identify agricultural information based on input of a query requesting the agricultural information. The computing platform may receive, from a user device, a query requesting the agricultural information. The computing platform may input, into the digital twin model, the query, to output the agricultural information based on the historical information and the relationships between the feature models. The computing platform may direct a vendor computing system to execute actions based on the agricultural information, which may cause the vendor computing system to execute the one or more actions.

### BACKGROUND

Aspects of the disclosure relate to digital twin modeling. In some cases, models, such as machine learning models, may be used for prediction. Due to limited computing resources, processing power, and/or machine learning model capabilities, the number of features considered by such models may be limited. For example, engineers, administrators, and/or other individuals may perform feature engineering to identify a subset of features, related to a use case that may have the greatest impact on the model's output. In such instances, however, remaining features may be disregarded. This may result in identification of an output that might not be as accurate as a hypothetical output in which all features were considered by the model. Accordingly, it may be advantageous to train, generate, and/or otherwise host a model capable of analyzing all related features of a use case (e.g., without limiting the number of features through feature engineering), while balancing the limitations of computing resources such as available memory, processing power, and/or other resources.

### SUMMARY

Aspects of the disclosure provide effective, efficient, scalable, and convenient technical solutions that address and overcome the technical problems associated with modeling for agricultural products. In accordance with one or more embodiments of the disclosure, a computing platform comprising at least one processor, a communication interface, and memory storing computer-readable instructions may receive historical information. The computing platform may train, using the historical information, a digital twin model, configured to identify agricultural information based on input of a query requesting the agriculture information, where training the digital twin model includes generating a knowledge graph, where each node of the knowledge graph corresponds to an individually trained feature model and each edge of the knowledge graph represents relationships between the feature models. The computing platform may receive, from a user device, a query requesting the agricultural information. The computing platform may input, into the digital twin model, the query, to output the agricultural information, where the digital twin model may output the agricultural information based on the historical information and the relationships between the feature models. The computing platform may send one or more commands to a vendor computing system directing the vendor computing system to execute one or more actions based on the agricultural information, which may cause the vendor computing system to execute the one or more actions.

In one or more instances, the historical information may be one or more of: weather information, economic information, geological information, event information, political information, pricing information, soil information, or geographic information. In one or more instances, the respective feature models may correspond to each of: the weather information, the economic information, the geological information, the event information, the political information, the pricing information, the soil information, or the geographic information.

In one or more examples, the relationships may indicate an effect on a second feature model occurring in response to a change in a first feature model. In one or more examples, the relationships may indicate one or more thresholds for the first feature model and corresponding data ranges for the second feature model, where the one or more thresholds may be based on average values for the first feature model and a predetermined number of standard deviations.

In one or more instances, the one or more thresholds may be dynamically adjusted based on average values for the first feature model. In one or more instances, the agricultural information may be one or more of: a predicted sale price for a crop, a predicted cost of production for the crop, a request to automatically select one or more crops for production, or a recommended piece of land for purchase.

In one or more examples, the computing platform may validate the relationships between the feature models based on the historical information. In one or more examples, the one or more actions may be automatically placing an order for seed of a crop identified in the agricultural information.

In one or more instances, the one or more actions may include automatically sending instruction that cause the seed to be dispensed. In one or more instances, the computing platform may receive, from the user device, feedback information indicating a level of satisfaction with the agricultural information. The computing platform may update, based on the feedback information and the agricultural information, the digital twin model using a dynamic feedback loop.

In one or more examples, the computing platform may receive updated information. The computing platform may dynamically modify, based on the updated information, the digital twin model, which may include one or more of: adding a new feature model, modifying existing relationships between the feature models, or adding new relationships between the feature models.

In one or more instances, the computing platform may send, to the user device, the agricultural information and one or more commands directing the user device to display the agricultural information, which may cause the user device to display the agricultural information. In one or more instances, the computing platform may receive, via a user interface of the user device, a user input, which may reject an initial recommendation of the agricultural information. The computing platform may modify the user interface to include an updated recommendation of the agricultural information based on the rejection.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for digital twin evaluation, prediction, and forecasting in accordance with one or more example embodiments;

FIGS. 2A-2D depict an illustrative event sequence for digital twin evaluation, prediction, and forecasting in accordance with one or more example embodiments;

FIG. 3 depicts an illustrative method for digital twin evaluation, prediction, and forecasting in accordance with one or more example embodiments;

FIGS. 4 and 5 depict illustrative graphical user interfaces for digital twin evaluation, prediction, and forecasting in accordance with one or more example embodiments; and

FIG. 6 depicts an illustrative digital twin model for evaluation, prediction, and forecasting in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances, other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further herein, one or more aspects of the disclosure describe a digital twin based evaluation, prediction, and forecasting engine for agricultural futures. A futures exchange or futures market is a central financial exchange where people may trade standardized futures contracts defined by the exchange. Futures contracts are derivatives contracts to buy or sell specific quantities of a commodity or financial instrument at a specified price with delivery set at a specified time in the future.

Agricultural commodity futures are market-based instruments for managing risks and they may help in orderly establishment of efficient agricultural markets. Future markets may be used to hedge commodity price risks. They may also serve as a low cost, highly efficient, and transparent mechanism for discovering prices in the future by providing a forum for exchanging information about supply and demand conditions. The hedging and price discovery functions of future markets may promote more efficient production, storage, marketing and agro-processing operations, and help in improvement in overall agricultural marketing performance.

Even in a normal year the agriculture market is impacted by many external factors such as weather related factors (e.g., climate, rain fail, and/or other weather factors), market related factors (e.g., consumer price index, inflation, and/or other market factors), and/or other factors.

With climate change induced weather and other impacts it is becoming more and more difficult to make reasonable predictions for the futures markets.

Accordingly, described herein is a system and method for a digital twin based evaluation, prediction, and forecasting method for the agricultural futures market.

In the current machine learning based forecasting technology for the agricultural product futures market, all the possible items that might influence the predictions are taken into account for building the model. This may include weather related items (e.g., climate, rain fall, humidity, and/or other weather information), economic information (e.g., tax, inflation, consumer price index, consumer tastes/trends, and/or other economic information), and/or other information. However, such factors may typically be considered together as if dumped into the same soup bowl. When data engineers work on all the data for data cleaning and dimension reduction of data, some of the data may be ignored in favor of simplifying the problem.

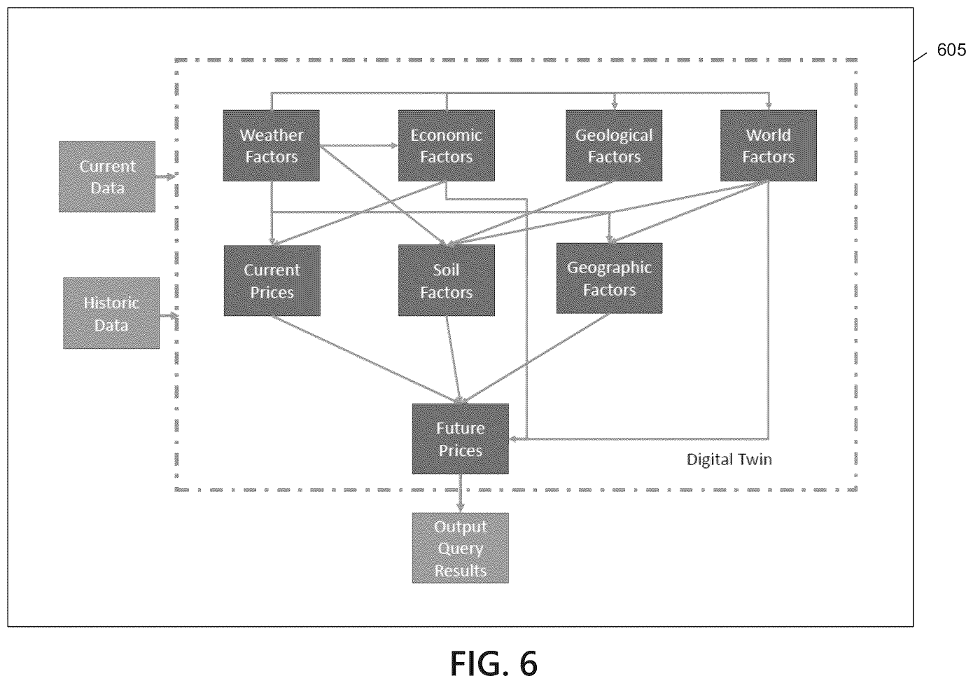

In contrast, the solution presented herein applies a digital twin model 605 as depicted in FIG. 6. The digital twin in this picture considers several factors, which are individually modeled. The modeling of each of these systems when modeled individually as separate systems may be more accurate than if a single model modelled all systems together. Although certain models and relationships between such models are illustrated in FIG. 6, this is for illustrative purposes only, and different models and/or relationships may make up the digital twin model 605 without departing from the scope of the disclosure.

Each of these systems may contribute individually or jointly to the future price for the agricultural products. The interrelationship of different systems may be described using a knowledge graph.

Each separate system may be modeled individually based on historic data and different types of artificial intelligence models may be put together in a digital twin system.

An illustrative example of the digital twin is shown in FIG. 6. The digital twin may take current data in real time or near real time as streaming or telemetry data. It also may have historic data. Based on the current and the historic data, predictive models may be built, updated, and maintained.

The output of the digital twin may be results of queries sent to the digital twin. The queries may be in the form of, for example, “tell me what the price of wheat will be in Country #1 three months from today,” or something to that effect.

Accordingly, described herein is a digital twin based evaluation, prediction, and forecasting method for the agricultural futures market comprising of interconnected systems such as a weather system, stock market system, and/or other systems, which may be independently modeled for accuracy, and their interdependencies and interconnectedness may be modeled by a knowledge graph. The digital twin may be provided with current and historic data for prediction purposes, and may be able to answer queries related to future agricultural commodity prices.

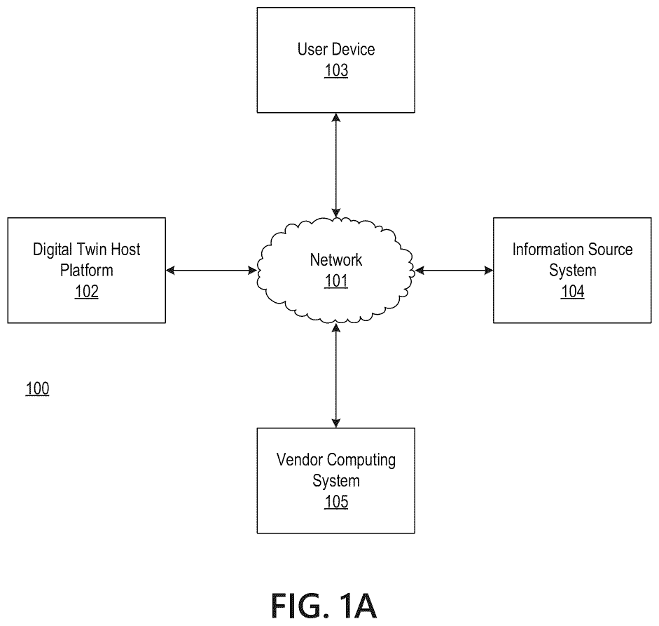

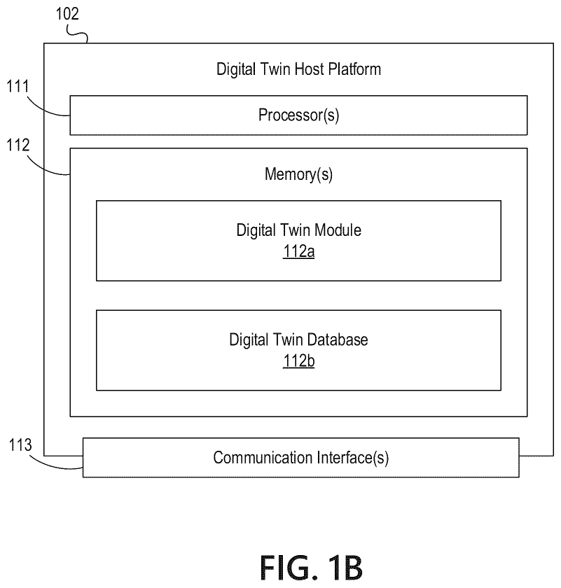

FIGS. 1A-1B depict an illustrative computing environment for digital twin evaluation, prediction, and forecasting in accordance with one or more example embodiments. Referring to FIG. 1A, computing environment 100 may include one or more computer systems. For example, computing environment 100 may include a digital twin host platform 102, user device 103, information source system 104, and vendor computing system 105.

As described further below, digital twin host platform 102 may be a computer system that includes one or more computing devices (e.g., servers, server blades, or the like) and/or other computer components (e.g., processors, memories, communication interfaces) that may be used to train, host, and/or otherwise refine a digital twin model, which may, e.g., include a knowledge graph linking together a plurality of individual feature models. In these instances, nodes of the knowledge graph may represent the feature models, and edges between the nodes may represent relationships between the feature models (e.g., how the operation and/or outputs of each model affects the others).

User device 103 may be a mobile device, tablet, smartphone, desktop computer, laptop computer, and/or other device that may be used by an individual (e.g., a client of a financial institution, investor, and/or other individual) to request agricultural information (e.g., futures information, predictions, and/or other information). In some instances, the user device 103 may be configured to provide one or more user interfaces (e.g., query response interfaces, or the like).

Information source system 104 may include one or more computing devices and/or other computer components (e.g., processors, memories, communication interfaces). In some instances, information source system 104 may include one or more data sources that may store historical information having an effect on agricultural futures (e.g., weather information, economic information, geological information, political information, current event information, pricing information, soil information, geographic information, and/or other information). Additionally or alternatively, the information source system 104 may include one or more real time sensors (e.g., internet of things sensors and/or other sensors), which may, e.g., provide real time information having an impact on agricultural futures. In some instances, these sensors may be located in or around various geographic locations.

Vendor computing system 105 may be or include one or more systems/devices such as a mobile device, tablet, smartphone, desktop computer, laptop computer, server, order placement/processing system, seed dispensing system, crop management system, water management system, land mapping system, and/or other device that may be used to execute one or more actions based on an output of the digital twin model (e.g., automatically place orders for seed of crops identified by the model, automatically plant the seed, generate a crop planting map indicating where certain crops should be planted, generate and/or submit land purchase agreements, and/or perform other actions). Although a single vendor computing system 105 is illustrated, any number of different vendor computing systems 105 may be included without departing from the scope of the disclosure.

Computing environment 100 also may include one or more networks, which may interconnect digital twin host platform 102, user device 103, information source system 104, vendor computing system 105, or the like. For example, computing environment 100 may include a network 101 (which may interconnect, e.g., digital twin host platform 102, user device 103, information source system 104, vendor computing system 105, or the like).

In one or more arrangements, digital twin host platform 102, user device 103, information source system 104, and/or vendor computing system 105 may be any type of computing device capable of sending and/or receiving requests and processing the requests accordingly. For example, digital twin host platform 102, user device 103, information source system 104, vendor computing system 105, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of digital twin host platform 102, user device 103, information source system 104, and/or vendor computing system 105 may, in some instances, be special-purpose computing devices configured to perform specific functions.

Referring to FIG. 1B, digital twin host platform 102 may include one or more processors 111, memory 112, and communication interface 113. A data bus may interconnect processor 111, memory 112, and communication interface 113. Communication interface 113 may be a network interface configured to support communication between digital twin host platform 102 and one or more networks (e.g., network 101, or the like). Memory 112 may include one or more program modules having instructions that when executed by processor 111 cause digital twin host platform 102 to perform one or more functions described herein and/or one or more databases that may store and/or otherwise maintain information which may be used by such program modules and/or processor 111. In some instances, the one or more program modules and/or databases may be stored by and/or maintained in different memory units of digital twin host platform 102 and/or by different computing devices that may form and/or otherwise make up digital twin host platform 102. For example, memory 112 may have, host, store, and/or include digital twin module 112a and a digital twin database 112b.

Digital twin module 112a may have instructions that direct and/or cause digital twin host platform 102 to execute advanced techniques to evaluate, predict, and/or forecast agricultural futures. In some instances, the digital twin module 112a may include a knowledge graph supported by (and storing relationships between) one or more feature models (which may, in some instances, be machine learning and/or other models). Digital twin database 112b may store information used by digital twin module 112a and/or digital twin host platform 102 to evaluate, predict, and/or forecast agricultural futures, and/or in performing other functions.

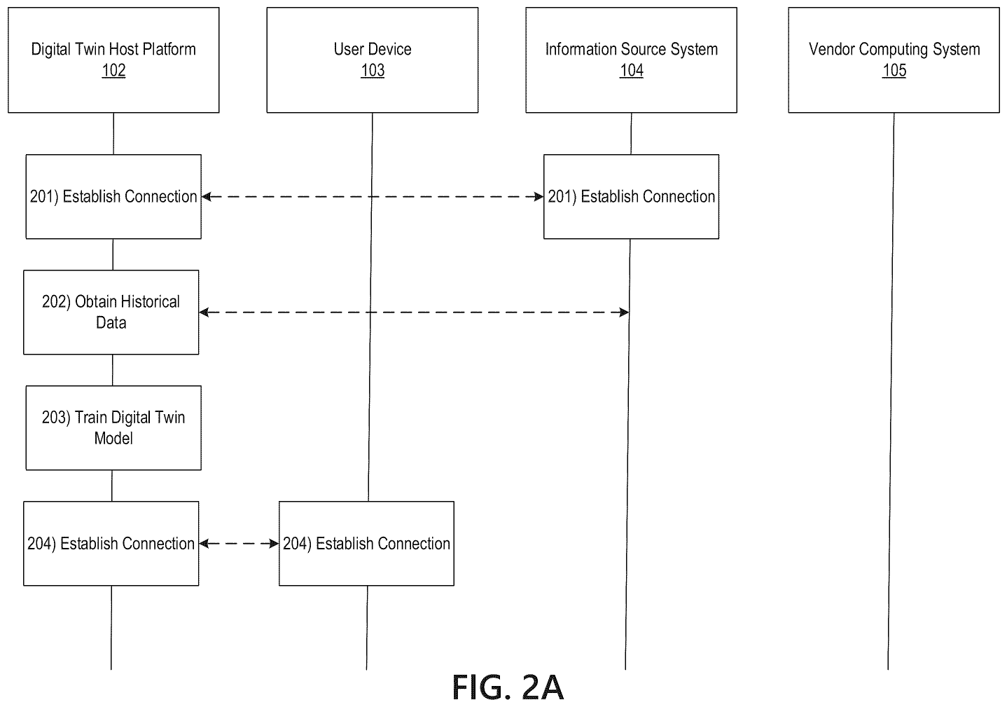

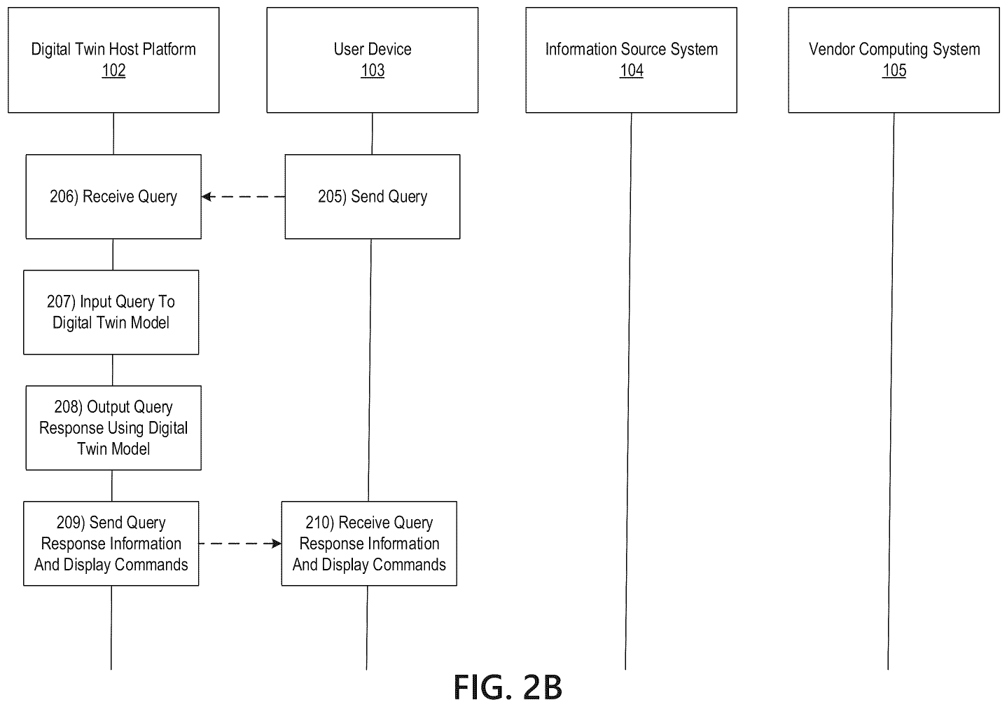

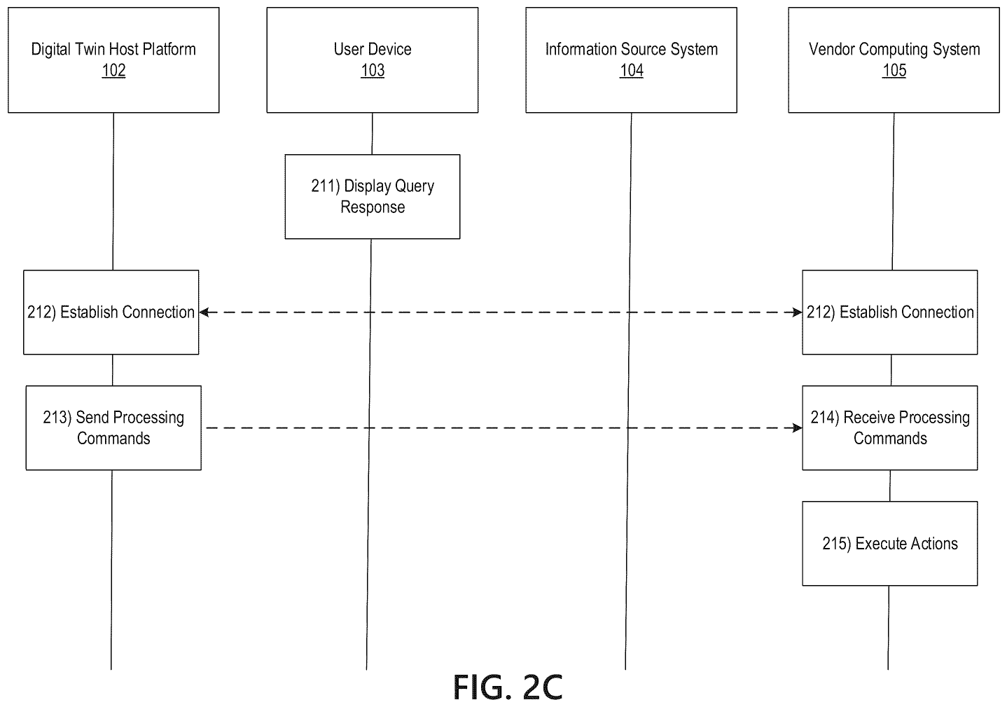

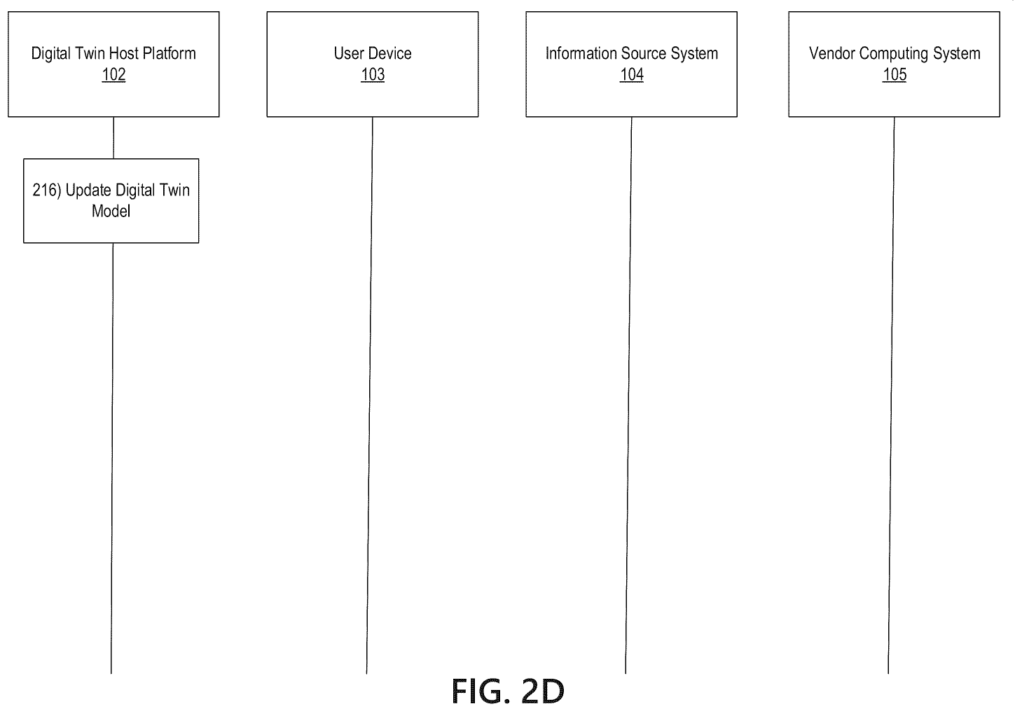

FIGS. 2A-2D depict an illustrative event sequence for digital twin based evaluation, prediction, and forecasting in accordance with one or more example embodiments. Referring to FIG. 2A, at step 201, information source system 104 may establish a connection with the digital twin host platform 102. For example, the information source system 104 may establish a first wireless data connection with the digital twin host platform 102 to link the information source system 104 to the digital twin host platform 102 (e.g., in preparation for sending historical information). In some instances, the information source system 104 may identify whether or not a connection is already established with the digital twin host platform 102. If a connection is already established with the digital twin host platform 102, the information source system 104 might not re-establish the connection. If a connection is not already established with the digital twin host platform 102, the information source system 104 may establish the first wireless data connection as described herein.

At step 202, the digital twin host platform 102 may obtain historical data from the information source system 104. For example, the digital twin host platform 102 may obtain the historical data from the information source system 104 via the communication interface 113 and while the first wireless data connection is established. For example, the digital twin host platform 102 may obtain weather information (e.g., precipitation levels, drought information, and/or other information), economic information (e.g., most profitable crops, inflation information, consumer preferences, and/or other information), geological information (e.g., ground conditions, terrain composition, and/or other information), political information (e.g., political conflicts, trade agreements, tax policies, and/or other information), world event information (e.g., conflicts or other events), pricing information (e.g., historic crop prices and/or other information), soil information (e.g., soil quality, nutrients, and/or other information), geographic information (e.g., what is the weather in a region, topography, population, and/or other information), and/or other information.

Although step 202 is described with regard to historical information, the information source system 104 may, in some instances, additionally or alternatively send real time information (similar to the historical information) at any point throughout the illustrative event sequence without departing from the scope of the disclosure. For example, real time information may be sent from one or more data sources, which may, e.g., include internet of things sensors, and/or other sensors/data sources.

At step 203, the digital twin host platform 102 may train or otherwise configure a digital twin model to estimate, forecast, and/or otherwise predict agricultural information. Individuals or enterprises involved in the agriculture industry may make decisions on what to produce, where to produce, and/or other decisions based on what they believe may result in the largest profits, most environmental benefit, and/or other criteria. Accordingly, a digital twin model may be trained to identify agricultural information (e.g., predicted prices, predicted costs, recommendations, and/or other information) based on historical information, current information, and/or queries, which may inform such decisions and/or automatically initiate actions accordingly.

To do so, the digital twin host platform 102 may generate a knowledge graph that includes the various features for consideration in producing agricultural futures information. In some instances, these features may correspond to the various types of historical information described above. In these instances, the digital twin host platform 102 may train models (e.g., machine learning models, artificial intelligence models, and/or other models) that may be used to output information corresponding to a particular feature over a particular time period. In some instances, the models may be the same type or different types of models, which may, for example, include, supervised learning techniques (e.g., decision trees, bagging, boosting, random forest, linear regression, neural networks, logistic regression, support vector machines, and/or other supervised learning techniques), unsupervised learning techniques (e.g., clustering, anomaly detection, and/or other unsupervised learning techniques), and/or other techniques. For example, the digital twin host platform 102 may train, using the historical information, a weather model, configured to analyze weather patterns, precipitation information, wind speeds, drought information, sun exposure, and/or other weather information. As another example, the digital twin host platform 102 may train, using the historical information, a current pricing model, configured to analyze average crop prices, market trends, land prices, production costs, and/or other information. Additionally or alternatively, the digital twin host platform 102 may train, using the historical information, a future pricing model, configured to predict, based on inputs from other feature models, future costs, prices, and/or other information related to agricultural products. Additionally or alternatively, the digital twin host platform 102 may train, using the historical information, an economic model, configured to analyze historic inflation information, production costs, consumer preferences, trends, profitability information, and/or other information. Additionally or alternatively, the digital twin host platform 102 may train, using the historical information, a world model, configured to analyze political information (e.g., conflicts, trade agreements, tax policies, and/or other information), world event information (e.g., conflicts or other events), and/or other information. Additionally or alternatively, the digital twin host platform 102 may train other models configured to provide outputs that may produce agricultural information (e.g., geological models, soil models, geographic models, and/or other models). In these instances, the digital twin host platform 102 may represent such trained models as nodes of the knowledge graph.

By training each model separately, the digital twin host platform 102 may consider information corresponding to each model in producing outputs (e.g., rather than limiting the amount of information considered using feature engineering, as is described further below). Furthermore, each model may have a different time scale, and thus the features corresponding to each model may have their own unique time scales accordingly.

Similarly, the digital twin host platform 102 may use edges of the knowledge graph (e.g., connecting the nodes) to represent relationships between the various models. Specifically, the relationships may indicate an effect that a change in a first feature model may have on a second feature model. For example, the edge between the weather model and the pricing model may indicate that lower amounts of precipitation cause higher current crop prices (e.g., due to the difficulty of growing crops under such conditions). As another example, the edge between the economic model and the pricing model may indicate that higher inflation leads to higher crop prices. Similarly, the edge between the weather factors and the geographic factors may indicate that climate changes reduce an amount of land available to produce a certain crop (which may, thus, in turn, result in higher prices). The knowledge graph may include a number of such edges between all of the models (not merely limited to the illustrative examples described above), which may indicate the interplay between the results of each model.

In some instances, these rules and/or relationships of the knowledge graph edges may be manually defined. Additionally or alternatively, the digital twin host platform 102 may automatically learn these relationships by analyzing the results of the various models for various agricultural information, so as to identify the most powerful correlating factors over time. For example, the digital twin host platform 102 may automatically set a rule if a predetermined number of digital twin simulations results in the given correlation (e.g., precipitation values that exceed a given threshold result in a lower price when compared to similarly situated crops in regions with precipitation values that do not exceed the given threshold).

In some instances, the edges between the nodes may represent relationships tied to threshold values and/or ranges. For example, the edge between the weather model and the current prices model may indicate that if rainfall is excessive, prices may increase (e.g., due to potential flooding, or the like). Similarly, if rainfall is minimal, prices may increase (e.g., due to potential drought, or the like). In these instances, the weather model may maintain threshold values for minimal and excessive rainfall, and may output to the pricing model only whether or not the corresponding value is minimal, normal, or excessive. In some instances, such threshold values may be automatically identified based on an average value (e.g., average rainfall), and corresponding standard deviations (e.g., two standard deviations on each side of the average value). Similarly, the pricing model may have predefined price ranges corresponding to each of minimal, normal, or excessive (e.g., rather than identifying an exact price based on an exact level of rainfall). In some instances, such thresholds may be dynamically and continuously adjusted by the digital twin host platform 102 based on, for example, variations in average values over time (e.g., so as to continuously refine the model to improve accuracy). Similar threshold/range relationships may be used to correlate the outputs between other feature models in the digital twin. In doing so, the digital twin host platform 102 may conserve computing resources by reducing processing power needed to identify the final output. In some instances, in addition or as an alternative to the range/threshold based approach described above, the digital twin model may be trained to identify more specific and/or exact effects (e.g., an exact amount of precipitation has an exact effect on pricing, or the like).

In some instances, the digital twin host platform 102 may back validate the relationships of the digital twin model using the historical information. For example, the digital twin host platform 102 may have both historical rainfall information and historical pricing information for a given crop over the last several years. The digital twin host platform 102 may validate that the relationship of the digital twin model between rainfall and pricing is correlated with the relationship between the historical rainfall information and historical pricing information stored in the digital twin. In doing so, the digital twin host platform 102 may verify accuracy of the relationships in the digital twin model, and make any necessary adjustments accordingly.

Accordingly, the digital twin host platform 102 may train the digital twin model to output agricultural information (e.g., recommendations, future pricing/costs, and/or other information) in response to a given query. For example, if a query is input requesting which crops to plant, the digital twin model may output a type of crop, corresponding price, recommended planting information, predicted costs, and/or other information.

In some instances, the digital twin host platform 102 may modify the digital twin over time so as to add new feature models, modify existing relationships between feature models, add new relationships between feature models, and/or otherwise as new data is received.

At step 204, the user device 103 may establish a connection with the digital twin host platform 102. For example, the user device 103 may establish a second wireless data connection with the digital twin host platform 102 to link the user device 103 to the digital twin host platform 102 (e.g., in preparation for inputting a query). In some instances, the user device 103 may identify whether or not a connection is already established with the digital twin host platform 102. If a connection is already established with the digital twin host platform 102, the digital twin host platform 102 might not re-establish the connection. If a connection is not yet established with the digital twin host platform 102, the digital twin host platform 102 may establish the second wireless data connection as described herein.

Referring to FIG. 2B, at step 205, the user device 103 may send a query to the digital twin host platform 102. For example, the user device 103 may send a request for a crop (or selection of crops) to plant, crop future pricing/cost information, where to plant, land to purchase, and/or other information. In some instances, the request may include a request to automatically act based on a response to the query (e.g., purchase and/or plant the corresponding seed, map the planting layout, and/or perform other actions). For example, the request may simply be to identify the most profitable crop arrangement for the user, and to order and/or plant the crops accordingly (e.g., without the user even knowing what is being ordered). For example, the request may ask for an instruction to be sent to another device associated with crop planting, such as a seed dispending system, or the like, directing the device to dispense seed. In some instances, the information source system 104 may send the query while the second wireless data connection is established.

At step 206, the digital twin host platform 102 may receive the query sent at step 205. For example, the digital twin host platform 102 may receive the query via the communication interface 113 and while the second wireless data connection is established.

At step 207, the digital twin host platform 102 may input the query into the digital twin model (e.g., trained at step 203) for analysis using the various feature models and relationships between them.

Although the transmission and receipt of the query is described at steps 205 and 206, additional information such as location information, land dimensions, budget information, planting goals, and/or other information may also be sent to and received by the digital twin host platform 102 without departing from the scope of the disclosure (e.g., which may be fed into the digital twin model along with the query for purposes of producing an output). In some instances, information may be sent by the user device 103, information source system 104, and/or one or more sensors (e.g., IoT sensors, or the like).

At step 208, the digital twin host platform 102 may output a query response using the digital twin model. For example, the digital twin host platform 102 may use the weather model to identify whether precipitation levels are low, normal, or excessive (e.g., by comparison to stored thresholds within the weather model). Based on this information, and the relationship defined in the digital twin between the weather model and the current pricing model, the digital twin host platform 102 may identify a current price range for various crops (e.g., different price ranges may be associated with each precipitation level classification for each crop). Using the relationship defined between the current pricing model and the future pricing model, the digital twin host platform 102 may similarly identify future price ranges for various crops. For example, the current price model may identify if current price ranges are low, normal, or high, the future pricing model may identify similar price ranges based on the correlation between the future pricing model and current pricing model. Accordingly, in the digital twin host platform 102 may output, for example, that the future pricing for a particular crop is higher than the prices for other crops.

As another illustrative example, an input query may request where a particular crop should be planted (either on a currently owned piece of property, prospective property, and/or otherwise). For example, some crops may be better produced on land with certain nutrients, in a certain climate, with a certain amount of rainfall, and/or otherwise. In these examples, the weather model may identify, for example, whether precipitation is low, normal, or high, and may output this to the soil model. In these instances, the relationship between the weather model and the soil model may indicate that soil may be classified as “good” if rainfall is “normal,” and “bad” if rainfall is either “low” or “high.” Similarly, a multiplier may be assigned by the relationship between the soil model and the future pricing model, indicating an adjustment to current pricing information based on the soil classification (e.g., multiply current price by 1.2 if “good” and 0.7 if “bad,” because poor soil condition may result in a worse harvest).

As yet another example, the economic model may identify whether inflation is low, normal, or high (e.g., by comparison to corresponding thresholds within the economic model). In these instances, a relationship between the economic model and the future pricing model may indicate a multiplier by which current price ranges should be adjusted to account for inflation (e.g., 1 for low inflation, 1.1 for normal inflation, 1.5 for high inflation, or the like), and the future pricing model may identify future price ranges accordingly for output.

By operating on such a basis where information in a model is generalized or categorized to identify an impact on a subsequent feature model, the digital twin may be flexible and robust against new situations. For example, in a scenario where a drought occurs, a shortage may be experienced. Similarly, shortages may be experienced for a variety of other reasons (e.g., lack of available land, repurposing of land, flooding, and/or otherwise). By training the digital twin to recognize simply the result of a situation, the digital twin model may be able to make decisions in situations that are otherwise incomparable to its stored historical data. For example, the digital twin may have historical data on droughts and the resulting effects, but not shortages due to repurposing of land. In these instances, the digital twin may be able to recognize that both instances cause a shortage, and may thus determine that both scenarios may have similar effects on subsequent models (e.g., both may result in higher current prices). This may be more flexible than a machine learning model applied to the same scenarios, which may need to be trained on the effects of both reasons for the shortage to produce a result. Such advantages may be applied across the range of models without departing from the scope of the disclosure.

The relationships between the weather model, current pricing model, economic model, soil model, and future pricing model are described for illustrative purposes. However, it should be understood that any number of various feature models within the digital twin and their corresponding relationships may be used to identify an output for the digital twin. For example, the weather model, current pricing model, and future pricing model may be defined by relationships where current prices rise due to drought (e.g., due to lower supply), thus causing increases in future prices as well. Additionally, the economic model and current pricing models may be defined by relationships where tax policies indicating whether it is more profitable to maintain land as commercial or residential may have impacts on the current pricing (e.g., whether it is more profitable to farm the land, or simply sell it—the repurposing of such land may reduce supply, and thus increase prices).

In some instances, the digital twin host platform 102 may also output a corresponding action (e.g., send a notification for display, send an order management command, send a system control command, and/or other actions). Using one or more of the various feature models within the digital twin, the digital twin host platform 102 may produce outputs such as pricing information, cost information, agriculture information (e.g., what to plant, where to plant, or the like), automated system control commands (e.g., automatically order and/or plant a crop, or the like), a map indicating which crops should be planted where, recommendations of land to purchase (e.g., for the purpose of planting crops on that land), and/or other outputs related to agriculture.

By performing this analysis, the digital twin host platform 102 may automatically identify the most cost effective way to produce agricultural products (e.g., by increasing quality, planting based on low production costs/high sale prices, and/or otherwise). Similarly, in some instances, the digital twin host platform 102 may go yet another step further and actually perform automated actions, corresponding to the production process, based on outputs of the digital twin model (e.g., placing orders, sending instructions to plant crops/dispense seed, adjusting watering cycles, purchasing land, modifying digital signage, and/or otherwise).

Additionally, using the digital twin may provide additional technical advantages over other automated techniques such as pure machine learning in the context of agricultural products. For example, in machine learning, due to limitations of processors, models, and/or other computing resources, the number of features considered in a machine learning model may be limited through feature engineering (e.g., so as to select features with the greatest impact on the model output, while disregarding others). In some instances, however, although the remaining features may have less impact on the machine learning output than the selected features, consideration of such remaining features may nevertheless increase accuracy of the final output. Accordingly, by training different models for each feature individually (e.g., rather than a single model trained to consider all features), all such features may be considered in the digital twin analysis. Furthermore, rather than merely outputting individual results from each model, by connecting the feature models through edges of a knowledge graph, the relationships between the outputs of each feature model may also be taken into account in the analysis. As a result, agricultural decisions may be made, taking into account all features that may have an impact, as well as the relationships between such features, thus increasing accuracy over traditional machine learning methods as well as balancing the limits of memory, processors, and/or other computing resources.

At step 209, the digital twin host platform 102 may send query response information, based on the output of the query, to the user device 103. For example, the digital twin host platform 102 may send pricing information, recommendation information, agricultural information, land information, and/or other information. In some instances, the digital twin host platform 102 may send one or more commands directing the user device 103 to display the query response information. In some instances, the digital twin host platform 102 may send the query response information and/or one or more commands directing the user device 103 to display the query response information while the second wireless data connection is established.

At step 210, the user device 103 may receive the query response information sent at step 209. For example, the user device 103 may receive the query response information while the second wireless data connection is established. In some instances, the user device 103 may also receive the one or more commands directing the user device 103 to display the query response information.

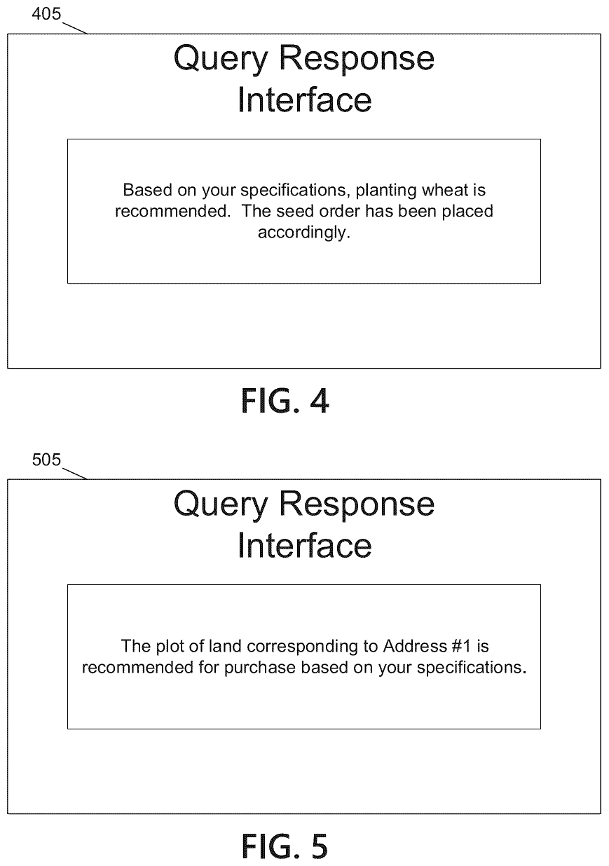

Referring to FIG. 2C, at step 211, based on or in response to the one or more commands directing the user device 103 to display the query response, the user device 103 may display the query response. For example, the user device 103 may display a graphical user interface similar to graphical user interface 405 in FIG. 4, which may recommend planting of a particular crop and/or may indicate that an order is automatically being placed. As another example, the user device 103 may display a graphical user interface similar to graphical user interface 505 in FIG. 5, which may recommend purchase of a particular plot of land.

In some instances, the user device 103 may receive a user selection or input via the interface, which may, e.g., cause the user device 103 and/or other devices to cause modification of one or more interface elements or otherwise modify backend data accordingly. For example, a user may order seed via an input to the user device 103, which may cause the user device 103 to move an order for the seed from a recommendations column of a stored (and/or displayed) table and into a pending orders column. Similarly, the user may be able to review proposed properties via the interface, and may be able to manipulate a stored (and/or displayed) table to move a particular property from a “pending review” column to a “selected for purchase” or “rejected properties” column. In some instances, where a user input rejects proposed or recommended agricultural information, the user interface may be updated to include an updated recommendation of different agricultural information based on the rejection.

At step 212, the digital twin host platform 102 may establish a connection with the vendor computing system 105. For example, the digital twin host platform 102 may establish a third wireless data connection with the vendor computing system 105 to link the vendor computing system 105 to the digital twin host platform 102 (e.g., in preparation for sending processing commands). In some instances, the vendor computing system 105 may identify whether a connection is already established with the vendor computing system 105. If a connection is already established with the vendor computing system 105, the digital twin host platform 102 might not re-establish the connection. If a connection is not yet established with the vendor computing system 105, the digital twin host platform 102 may establish the third wireless data connection as described herein.

At step 213, the digital twin host platform 102 may send one or more processing commands to the vendor computing system 105. For example, the digital twin host platform 102 may send one or more processing commands to the vendor computing system 105 via the communication interface 113 and while the third wireless data connection is established. For example, the digital twin host platform 102 may send commands directing the vendor computing system 105 to place or otherwise fulfill an order for seed (e.g., the vendor computing system 105 may be an order fulfillment or management system). Additionally or alternatively, the digital twin host platform 102 may send commands directing the vendor computing system 105 to plant seed once obtained (e.g., the vendor computing system 105 may be an automated planting system). Additionally or alternatively, the digital twin host platform 102 may send commands directing the vendor computing system 105 to modify scheduling and/or functionality of a watering system, such as increase or reduce frequency, volume, and/or other functions (e.g., the vendor computing system 105 may be a watering system). Additionally or alternatively, the digital twin host platform 102 may send commands directing the vendor computing system 105 to place a sale contract or other purchasing communication related to a piece of land (e.g., the vendor computing system 105 may be a realtor computing system). In some instances, the digital twin host platform 102 may direct the vendor computing system 105 to perform other actions. Accordingly, any number of vendor computing systems 105 may be used to implement the methods described herein without departing from the scope of the disclosure, despite only a single vendor computing system 105 being illustrated in the figures.

In some instances, various agricultural information (e.g., type of crops, land, or the like) may have a corresponding list of actions to be performed if output. For example, the purchasing or fulfilment systems for a particular crop, planting schedules, watering schedules, and/or other information may be in the playbook or list of rules for that crop (e.g., different for wheat vs. corn). Similarly, if land is identified, the corresponding real estate systems may be involved. In these instances, the digital twin host platform 102 may store the playbooks for the various crops or other agricultural information, and may select the playbook accordingly based on an output of the digital twin model.

At step 214, the vendor computing system 105 may receive the one or more processing commands sent at step 213. For example, the vendor computing system 105 may receive the one or more processing commands while the third wireless data connection is established.

At step 215, based on or in response to the one or more processing commands, the vendor computing system 105 may execute one or more actions. For example, the vendor computing system 105 may perform one or more of the actions noted above (e.g., place/fulfill an order, execute planting actions, adjust watering functions, purchase real estate, or the like) and/or perform other actions.

Referring to FIG. 2D, at step 216, the digital twin host platform 102 may update the digital twin model based on any outputs of the model, updated information, and/or feedback (e.g., indicating a level of satisfaction with the agricultural information) received (e.g., via the interfaces). For example, the digital twin host platform 102 may update one or more thresholds, value ranges, and/or other information. In doing so, the digital twin host platform 102 may dynamically and continuously update and/or otherwise refine the digital twin model using a dynamic feedback loop so as to increase accuracy of the feature models, knowledge graph, simulations, and/or other aspects of the digital twin model. In some instances, the digital twin host platform 102 may identify that accuracy of the digital twin model has exceeded a threshold value (e.g., 99%, or the like) based on, for example, acceptance of recommendations provided as outputs to the digital twin model and/or otherwise. In these instances, the digital twin host platform 102 may identify that accuracy need not be further increased, and thus may stop refinement of the model until accuracy falls below the threshold value. In doing so, the digital twin host platform 102 may conserve processing resources by refining the digital twin model only when necessary to cause noticeable or otherwise appreciated increases in accuracy.

Although the above described method is primarily described in the context of an agricultural information, the method may be applied to other contexts without departing from the scope of the disclosure. Similarly, although the method is primarily described in the context of individuals making agricultural decisions, it may similarly be used by analysts or other finance professionals to identify agricultural futures pricing for the purpose of executing purchases, sales, trades, or the like of various commodities.

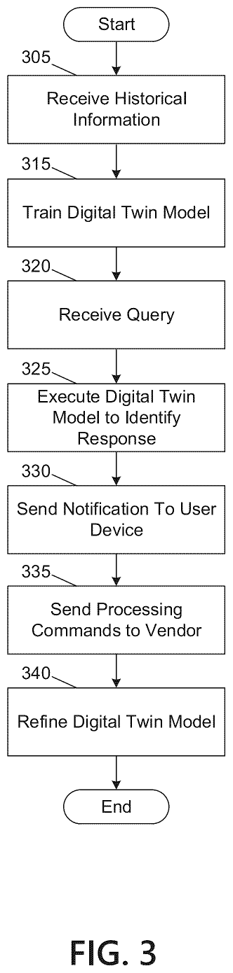

FIG. 3 depicts an illustrative method for digital twin evaluation, prediction, and forecasting in accordance with one or more example embodiments. Referring to FIG. 3, at step 305, a computing platform having at least one processor, a communication interface, and memory may receive historical information. At step 315, the computing platform may train a digital twin model using the historical information. At step 320, the computing platform may receive a query. At step 325, the computing platform may execute the digital twin model to identify a query response. At step 330, the computing platform may send a notification to a user device including the query response. At step 335, the computing platform may send one or more processing commands to the vendor computing system directing the vendor computing system to execute one or more actions. At step 340, the computing platform may refine the digital twin model.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
receive historical information;
train, using the historical information, a digital twin model, configured to identify agricultural information based on input of a query requesting the agricultural information, wherein training the digital twin model comprises generating a knowledge graph, wherein each node of the knowledge graph corresponds to an individually trained feature model and each edge of the knowledge graph represents relationships between the feature models;
receive, from a user device, a query requesting the agricultural information;
input, into the digital twin model, the query, to output the agricultural information, wherein the digital twin model outputs the agricultural information based on the historical information and the relationships between the feature models; and
send one or more commands to a vendor computing system directing the vendor computing system to execute one or more actions based on the agricultural information, wherein sending the one or more commands to the vendor computing system causes the vendor computing system to execute the one or more actions.

2. The computing platform of claim 1, wherein the historical information comprises one or more of: weather information, economic information, geological information, event information, political information, pricing information, soil information, or geographic information.

3. The computing platform of claim 2, wherein the respective feature models correspond to each of: the weather information, the economic information, the geological information, the event information, the political information, the pricing information, the soil information, or the geographic information.

4. The computing platform of claim 1, wherein the relationships indicate an effect on a second feature model occurring in response to a change in a first feature model.

5. The computing platform of claim 4, wherein the relationships indicate one or more thresholds for the first feature model and corresponding data ranges for the second feature model, wherein the one or more thresholds are based on average values for the first feature model and a predetermined number of standard deviations.

6. The computing platform of claim 5, wherein the one or more thresholds are dynamically adjusted based on average values for the first feature model.

7. The computing platform of claim 1, wherein the agricultural information comprises one or more of: a predicted sale price for a crop, a predicted cost of production for the crop, a request to automatically select one or more crops for production, or a recommended piece of land for purchase.

8. The computing platform of claim 1, wherein the memory stores additional computer-readable instructions that, when executed by the one or more processors, further cause the computing platform to:
validate the relationships between the feature models based on the historical information.

9. The computing platform of claim 1, wherein the one or more actions comprise automatically placing an order for seed of a crop identified in the agricultural information.

10. The computing platform of claim 9, wherein the one or more actions comprise automatically sending instructions that cause the seed to be dispensed.

11. The computing platform of claim 1, wherein the memory stores additional computer-readable instructions that, when executed by the one or more processors, further cause the computing platform to:
receive, from the user device, feedback information indicating a level of satisfaction with the agricultural information; and
update, based on the feedback information and the agricultural information, the digital twin model using a dynamic feedback loop.

12. The computing platform of claim 1, wherein the memory stores additional computer-readable instructions that, when executed by the one or more processors, further cause the computing platform to:
receive updated information; and
dynamically modify, based on the updated information, the digital twin model, wherein dynamically modifying the digital twin model comprises one or more of: adding a new feature model, modifying existing relationships between the feature models, or adding new relationships between the feature models.

13. The computing platform of claim 1, wherein the memory stores additional computer-readable instructions that, when executed by the one or more processors, further cause the computing platform to:
send, to the user device, the agricultural information and one or more commands directing the user device to display the agricultural information, wherein the one or more commands directing the user device to display the agricultural information cause the user device to display the agricultural information.

14. The computing platform of claim 13, wherein the memory stores additional computer-readable instructions that, when executed by the one or more processors, further cause the computing platform to:
receive, via a user interface of the user device, a user input, wherein the user input rejects an initial recommendation of the agricultural information; and
modify the user interface to include an updated recommendation of the agricultural information based on the rejection.

15. A method comprising:
at a computing platform comprising at least one processor, a communication interface, and memory:
receiving historical information;
training, using the historical information, a digital twin model, configured to identify agricultural information based on input of a query requesting the agricultural information, wherein training the digital twin model comprises generating a knowledge graph, wherein each node of the knowledge graph corresponds to an individually trained feature model and each edge of the knowledge graph represents relationships between the feature models;
receiving, from a user device, a query requesting the agricultural information;
inputting, into the digital twin model, the query, to output the agricultural information, wherein the digital twin model outputs the agricultural information based on the historical information and the relationships between the feature models; and
sending one or more commands to a vendor computing system directing the vendor computing system to execute one or more actions based on the agricultural information, wherein sending the one or more commands to the vendor computing system causes the vendor computing system to execute the one or more actions.

16. The method of claim 15, wherein the historical information comprises one or more of: weather information, economic information, geological information, event information, political information, pricing information, soil information, or geographic information.

17. The method of claim 16, wherein the respective feature models correspond to each of: the weather information, the economic information, the geological information, the event information, the political information, the pricing information, the soil information, or the geographic information.

18. The method of claim 15, wherein the relationships indicate an effect on a second feature model occurring in response to a change in a first feature model.

19. The method of claim 18, wherein the relationships indicate one or more thresholds for the first feature model and corresponding data ranges for the second feature model, wherein the one or more thresholds are based on average values for the first feature model and a predetermined number of standard deviations.

20. One or more non-transitory computer-readable media storing instructions that, when executed by a computing platform comprising at least one processor, a communication interface, and memory, cause the computing platform to:
receive historical information;
train, using the historical information, a digital twin model, configured to identify agricultural information based on input of a query requesting the agricultural information, wherein training the digital twin model comprises generating a knowledge graph, wherein each node of the knowledge graph corresponds to an individually trained feature model and each edge of the knowledge graph represents relationships between the feature models;
receive, from a user device, a query requesting the agricultural information;
input, into the digital twin model, the query, to output the agricultural information, wherein the digital twin model outputs the agricultural information based on the historical information and the relationships between the feature models; and
send one or more commands to a vendor computing system directing the vendor computing system to execute one or more actions based on the agricultural information, wherein sending the one or more commands to the vendor computing system causes the vendor computing system to execute the one or more actions.
